(19) United States
(12) Patent Application Publication
(10) Pub. No.: US 2021/0304933 A1
(43) Pub. Date: Sep. 30, 2021

(54) SYNTHESIS OF HIGH PURITY MANGANESE BISMUTH POWDER AND FABRICATION OF BULK PERMANENT MAGNET

(71) Applicant: Iowa State University Research Foundation, Inc., Ames, IA (US)

(72) Inventors: Wei Tang, Ames, IA (US); Gaoyuan Ouyang, Ames, IA (US); Baozhi Cui, Ames, IA (US); Jun Cui, Ames, IA (US)

(21) Appl. No.: 16/974,279

(22) Filed: Dec. 15, 2020

Related U.S. Application Data
(60) Provisional application No. 63/100,678, filed on Mar. 24, 2020.

(51) Int. Cl. H01F 1/22; B22F 3/10; C22C 22/00

(52) U.S. Cl. CPC H01F 1/22; B22F 2304/10; C22C 22/00; B22F 3/1028

(57) ABSTRACT

A synthesis process is disclosed for fabrication of mass quantities of high-purity α-MnBi magnetic powder and subsequent bulk permanent magnet. An illustrative process includes certain steps that include: multiple annealing, multiple comminuting such as multiple ball milling, forming a non-magnetic phase on and/or in the powder particles at particle grain boundaries before particle consolidation such as pressing, and magnetic annealing of a pressed compact. A reproducible and high productive synthesis process is created by combining these steps with other steps, which makes possible production of mass quantities of MnBi powder and bulk magnets with high performance.

### RELATED APPLICATION

This application claims benefit and priority of provisional application Ser. No. 63/100,678 filed Mar. 24, 2020, the disclosure and drawings of which are incorporated herein by reference.

### CONTRACTUAL ORIGIN OF THE INVENTION

This invention was made with Government support under Contract DE-AC02-07CH11358 awarded by the U.S. Department of Energy. The Government has certain rights in the invention.

### FIELD OF THE INVENTION

The present invention relates generally to the processes for large scale manufacturing of non-rare earth permanent magnets with high performance. More particularly, the present invention relates to processes for production of large-scale quantities of high-purity manganese bismuth powders and corresponding high performance bulk permanent magnets for energy conversion applications.

### BACKGROUND OF THE INVENTION

Manganese Bismuth (MnBi) is an attractive alternative to permanent magnets containing rare earth elements such as NdFeB—Dy and SmCo used in medium-temperature (423 K to 473 K) applications. MnBi has unique temperature properties. For example, MnBi has a coercivity (H_{c}) value that increases with increasing temperature, reaching a maximum of 2.6 T at 523 K (250° C.). This large coercivity is attributed to MnBi's large magnetocrystalline anisotropy (1.6×10⁶ J/m³). MnBi has a relatively low magnetization value. At room temperature, its saturation magnetization is about 75 emu/g or 8.4 kG in a T field. The corresponding maximum theoretical energy product (BH)ₘₐₓ is about 17.6 MGOe. The roadmap for developing a MnBi-based magnet starts with preparing a high purity MnBi compound in a large quantity. However, synthesizing MnBi is a challenge. Melting temperatures of Mn and Bi are 1519 K (1246° C.) and 544 K (271° C.), respectively. The Mn—Bi phase diagram (ASM Alloy Phase Diagram Database, ASM International, Materials Park, OH, USA) shows that undesired peritectic reactions occur over a wide range of temperatures and compositions. Processes are further complicated by a eutectic reaction that occurs between liquid bismuth (Bi) metal and solid MnBi at a temperature of 535 K (262° C.), which limits the maximum temperature to which composite materials can be exposed. While this eutectic temperature is about 112 K higher than the desired operating temperature of 423 K (150° C.), it is low for fabrication methods that include sintering and hot pressing for typical bulk magnets.

Several parameters are used to characterize a magnetic material: remanent magnetization (Bᵣ), coercivity force (H_{c}), and maximum energy product ((BH)ₘₐₓ). The (Bᵣ) value is a measure of magnet strength in the absence of an external magnetic field. The coercivity force or value (H_{c}) is a measure of a magnetic material's ability to remain magnetized in an external field. (BH)ₘₐₓ represents the maximum product between an induced magnetization value and a corresponding applied field. However, a high (Bᵣ) value or a high (H_{c}) value does not mean a high (BH)ₘₐₓ value, as many magnetic materials retain either a high (Bᵣ) value or a high (H_{c}) value, but not both. TABLE 1 lists properties of several important magnetic materials, including MnBi.

TABLE 1 lists magnetic properties of common magnetic materials.

| | Magnetization | Coercivity | Energy Product |
|---|---|---|---|
| | (Bᵣ) Kg | (H_{c}) kOe | (BH)ₘₐₓ MGOe |
| Fe₁₄Nd₂B | 12 | 12 | 40 |
| AlNiCo-9 | 10.5 | 1.6 | 8.5 |
| MnBi | 5.9 | 7.4 | 8.3 |
| Fe | 21.5 | 0.001 | 0.02 |
| FeCo | 24.5 | 0.002 | 0.05 |

“Hard” magnetic materials do not magnetize or de-magnetize easily. “Soft” magnetic materials magnetize and de-magnetize easily. A magnetic material is considered “hard” if its coercivity (H_{c}) is greater than 1000 Oe, and “soft” if the (H_{c}) value is less than 100 Oe. Generally, “hard” permanent magnets have a coercivity value greater than 3000 Oe, and, in some case, a coercivity value over 10,000 Oe. “Soft” magnetic materials typically exhibit a coercivity (H_{c}) less than 10 Oe, and, in some cases, a coercivity (H_{c}) of 0.1 Oe.

Major conventional approaches are used to prepare single-phase MnBi materials, including arc-melting, melt-spinning/rapid solidification and sintering. In the melt spinning approach, rapid cooling freezes MnBi in an amorphous phase. Subsequent heat treatment allows the amorphous phase to crystalize yielding low-temperature phase (LTP) MnBi, also referred hereby as α-MnBi, at a purity over 90% by volume. However, it was not reported to constantly produce large quantities of high pure LTP MnBi ribbons, because the initial compositions and subsequent heat treatment temperatures were not well selected or controlled. The productivity of the conventional melt spinning approach is very limited.

In the sintering approach, LTP MnBi phase is obtained through a powder metallurgy process in which powders of Mn and Bi are mixed and then sintered. However, this approach provides a yield of less than 50% LTP MnBi. In addition, the LTP MnBi alloy is not easily separated from unreacted manganese (Mn) and bismuth (Bi) metal phases in the composite material.

In the arc-melting/induction-melting approach, LTP phase MnBi is produced via conventional casting followed by heat treatment. In this approach, the ingot obtained by arc-melting or induction-melting is annealed at 300° C. for 24 hours. The annealed ingot exhibits a saturation magnetization (Mₛ) of 60 emu/g in an applied field of 30 kOe at room temperature, which is equivalent to a purity of MnBi of 74%, assuming the Mₛ of 100% pure LTP MnBi is 81 emu/g in an applied field of 30 KOe. The conventional processes cannot produce LTP MnBi at a purity greater than 90%.

Precursor MnBi materials with high percentage of LTP MnBi phase need to be ball milled to obtain feedstock powder with a particle size of 3˜5 μm. The feedstock powder is magnetically aligned and pressed to obtain green compacts. Subsequently, the green compacts are further consolidated/densified to form bulk magnets. A conventional consolidation is to hot-press on the green compacts at a temperature of 250-290 C. The hot press approach can achieve a full density to bulk magnets. However, it deteriorates magnetic alignment of bulk magnets due to a uniaxial press force, leading to decrease of magnetic properties. In addition, the productivity and magnet dimensions of the hot press approach are very limited.

### SUMMARY OF THE INVENTION

Accordingly, a new method is needed to produce mass quantities of high-purity MnBi (>90% by volume low temperature α phase) feedstock powder and fabricate large size bulk magnets with high performance for high temperature applications. The present invention addresses this need by providing a method having certain combination of novel steps to produce improved feedstock powder and resulting bulk magnets to these ends.

### BRIEF DESCRIPTION OF THE DRAWINGS

FIG. 1 is a schematic view showing process steps for making MnBi powder and a permanent magnet pursuant to an embodiment of the invention.

FIG. 2 is a flow chart of making MnBi precursor alloys.

FIG. 3 is a flow chart of making MnBi feedstock powder.

FIG. 4 is a flow chart of making a MnBi bulk magnet.

FIG. 5a and FIG. 5b are XRD patterns of MnBi precursor alloys before and after annealing, respectively, of a cast ingot whose XRD patterns are designated “a.” and melt spun ribbons designated “b.”.

FIG. 6 shows the magnetic properties of MnBi precursor ribbons annealed at 290 degrees C. for 5 days.

FIG. 7 shows the magnetic properties of MnBi feedstock powder.

FIG. 8a is a schematic view of loose grain particles sans non-magnetic grain boundary phase and magnetic properties of loose MnBi feedstock powder and after compaction. FIG. 8b is a schematic view of compacted MnBi grains having a non-magnetic grain boundary phase (blackened line around particles) pursuant to an embodiment of the invention.

FIG. 9a shows magnetic properties of MnBi feedstock powders made by forming a Bi-rich phase by adjusting the starting alloy composition and FIG. 9b shows the magnetic properties of MnBi feedstock powders having about 0.5 weight % of the fine powder provided as a Bakelite coating on surfaces of the fine powder. The magnetic properties are compared to the bulk magnet.

FIG. 10 shows magnetic properties of MnBi feedstock powders coated with Zn (0.5 weight % and 1.5 weight % Zn of the powder) versus uncoated powders ‘Powder”.

FIG. 11 shows magnetic properties of a bulk magnet annealed at different temperatures show on the graph.

FIG. 12 shows high temperature magnetic properties of a typical bulk magnet produced by practicing all process steps pursuant to an embodiment of the invention.

### DESCRIPTION OF THE INVENTION

The following description provides illustrative process embodiments for fabrication of mass quantities of high-purity MnBi (preferably >90-92% or more by volume α phase MnBi feedstock powder (where the α phase is referred to as LTP below) and large size bulk MnBi permanent magnets. The following description includes an illustrative mode of the present invention which is offered for purposes of illustration and not limitation. While the invention can be practiced with various modifications and alternative constructions, there is no intention to limit the invention to the specific forms disclosed. The invention is intended to cover all modifications, alternative constructions, and equivalents falling within the spirit and scope of the invention as defined in the claims. Therefore the present description should be seen as illustrative and not limiting.

An illustrative process is disclosed for fabrication of mass quantities of high-purity LTP (>90% α phase) MnBi feedstock powder and large size bulk MnBi permanent magnets. The term “mass quantity” as used herein means a scalable quantity greater than 1000 grams feedstock powder with reproducible magnetic properties (Mₛ>70 emu/g, H_{cj}>10 KOe) where Mₛ is saturation magnetization. The term “Large size” as used herein means the dimensions of bulk magnets up to 2 inches.

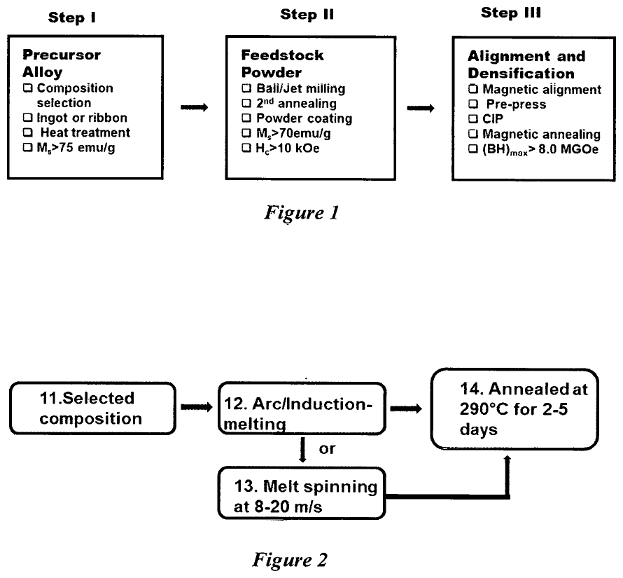

Illustrative embodiments of the present invention involve processing that may include three major steps as shown in FIG. 1: namely; fabrication of precursor alloy, fabrication of feedstock powder, and fabrication of bulk magnet.

In step I illustrated in FIG. 2, the flow chart of fabrication of precursor alloys is shown. Manganese (Mn) and Bismuth (Bi) metals with varied compositions (e.g. MnₓBi₁₀₀₋ₓ, x=48.5-53.5 at. %) are arc-melted or induction-melted. In an illustrative embodiment, the molten alloy is poured into a Cu (or other heat conductive) mold cooled by chill water so as to effect rapid solidification and form a uniform ingot in the mold. For purposes of further illustration and not limitation, a typical induction-melted ingot has a 1.5 kg mass and in the form of a 1″ in diameter rod. The obtained ingot then is melt spun to obtain melt spun ribbons. The melt spun ribbons are annealed in a vacuum of 1×10⁻³ Torr or below at 270 to 350° C. such as 290° C. for 2-6 days. Alternatively, the ingot can be directly annealed in a vacuum at the same temperature and time. The annealed ingot or ribbon are ground into 425 μm powder. The coarse precursor powders obtained by grinding the ingots and ribbons achieve an Average Mₛ of 70 and 75 emu/g (or 90-92% LTP MnBi phase), respectively, and are ready for next step.

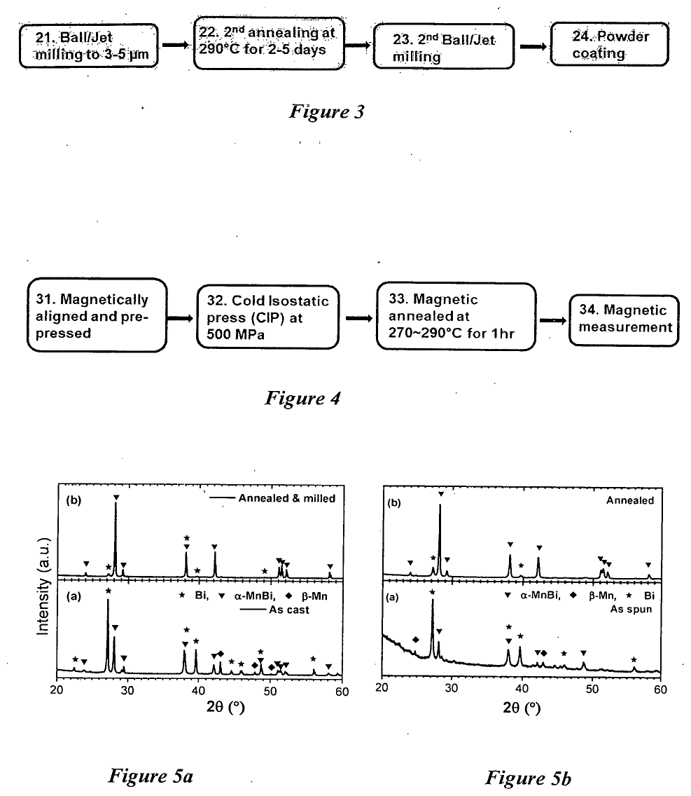

In step II, the process flow chart of fabrication of feedstock powder is shown in FIG. 3. The coarse precursor powder with a particle size of about 425 μm is ball or jet milled down to 3-5 μm size. During the process of ball/jet milling, with decreasing particle size of powder, partial amounts of powder may be decomposed such that a tiny amount of amorphous MnBi phase is formed at the surface of particles due to the collision of powders to balls or themselves, which results in decrease of Mₛ. On the other hand, H_{cj} increases with decreasing particle size. In order to recover Mₛ, the ball/jet milled powder is second annealed at 270 to 350° C. such as 290° C. for 2-5 days. The 2^{nd} annealing is a process step to crystallize the amorphous phase and recombine the decomposed phase so that the Mₛ of fine powder can be partially recovered. However, such a prolonged annealing at 270 to 350° C. such as 290° C. to the fine powder leads to agglomeration of particles, which impacts on magnetic alignment in the next step be described. Therefore, the 2^{nd} annealed powder is ball milled for a short time such as 1 hour or jet milled one time to break down the agglomeration of particles. After 2^{nd} annealing and ball/jet milling, the fine powder has a Mₛ of up to 73 emu/g and a H_{cj} of higher than 10 kOe.

In the manufacture of bulk permanent magnets, it is well known that the microstructure of any useful permanent magnet mainly must consist of magnetically hard and soft phases. The magnetically hard phase may comprise matrix grains, while the magnetically soft phase is located at grain boundaries. Or, the soft phase is a matrix phase, while the hard phase is embedded into the matrix. Such a net structure of magnets can resist the domain movement in a magnetization reversal to obtain or retain coercivity. The 2^{nd} annealed fine powder has higher than 90% LTP MnBi hard phase. In order to retain coercivity of bulk magnets, the present invention envisions introducing a non-magnetic phase as described below. Illustrative embodiments of the present invention provide two approaches or a combination of these approaches to this end, so-called interior and/or exterior methods that can be applied to introduce a new phase into grain boundary regions of bulk magnets. In the so-called interior approach, Bi-enriched phase is interiorly introduced by adjusting compositions of starting alloys. For purposes of illustration and not limitation, a typical composition can be Mn_{49.5}Bi_{50.5}. Since the LTP MnBi hard phase is formed at a ratio of Mn₅₀Bi₅₀, excess Bi of the composition will form a Bi-enriched soft phase that is distributed at the grain boundaries of bulk magnets and formed in the particles by the multiple annealing steps at 270 to 350° C. such as 290° C. described above and/or by magnetically annealing at 270-350 degrees C. to be described below with respect to FIG. 4. Another approach is to exteriorly introduce a soft phase by coating non-magnetic material on the outer surfaces of fine MnBi particles at the time of feedstock processing, FIG. 3, wherein the fine particle size (e.g. 3 to 5 microns) corresponds substantially to the grain size of the final bulk magnet. The coating preferably covers the entire outer surfaces of the fine particles; although less than complete coverage of the particle surfaces by the coating can be employed so long as magnetic properties such as Mₛ and H_{cj} are acceptable for a given magnet application. These non-magnetic coating materials include, but not limited to Zn, Bi, Sn, Sb, Bakelite or other polymers, etc. Since addition of any non-magnetic phase can dilute the magnetic phase, the added amount is controlled to 2 weight % or less of the bulk magnet weight, which limited amount does not substantially affect Mₛ but can effectively retain values of H_{cj}. For the next steps III and so on, the coated or composition-modified fine MnBi powder is taken as feedstock powder.

In step III, the process flow chart of fabrication of bulk magnets is shown in FIG. 4. Feedstock powder is loaded into a non-magnetic metal pressing die (e.g. Inconel die and punch), or other die such as a rubber or other die, in a glove box with a nitrogen atmosphere. The die with the feedstock powder is wrapped and sealed by a flexible balloon (e.g. a large party balloon) or other plastic or rubber bag, and then moved into an electromagnet so that the powder particles are aligned in a magnetic field of 1.5 T. Subsequently, the aligned powder is uniaxially pre-pressed (0.5-1.0 ksi) in the die using a die punch to obtain a partially dense green compact. The pre-press force depends on the size of green compacts. After the green compact is taken out from the die, the green compact is wrapped in a flexible balloon or bag in the nitrogen glove box. Afterward, the green compact wrapped by the balloon or bag is cold isostatic pressed (CIP) at a pressure of 500 MPa and room temperature. The CIP densified compact then is sealed in a quartz tube in a vacuum of 1×10⁻² Torr and then magnetically annealed at 270-350° C. for 1 hour under a magnetic field of 0.5-3.0 T to obtain a bulk magnet with a density of 8.0 g/cc or above and having a non-magnetic phase (e.g. the Zn coating and/or the Bi-rich phase) at grain boundaries of the bulk magnet. Additional LTP MnBi can be formed at the grain boundaries by the magnetic annealing heat treatment. The magnetic annealing is a process step to further improve the alignment of bulk magnets and thus enhance the magnetic properties, especially for (BH)ₘₐₓ of bulk magnets. The magnetic properties of bulk magnets are measured by a hysteresis graph plotter with a magnetic field of 2 T, or a VSM (vibrating sample magnetometer) with a field of 3 or 9 T to evaluate the bulk magnets.

The processing embodiments disclosed above enable fabrication of mass quantities of high-purity (>92%) LTP MnBi feedstock powder and large size bulk MnBi permanent magnets.

FIGS. 5a and 5b. illustrate XRD patterns of precursor alloys before and after the process step 11 and step 14 in FIG. 2 are completed. It is seen that a prolonged annealing is an effective way to achieve high volume fraction of the LTP MnBi phase.

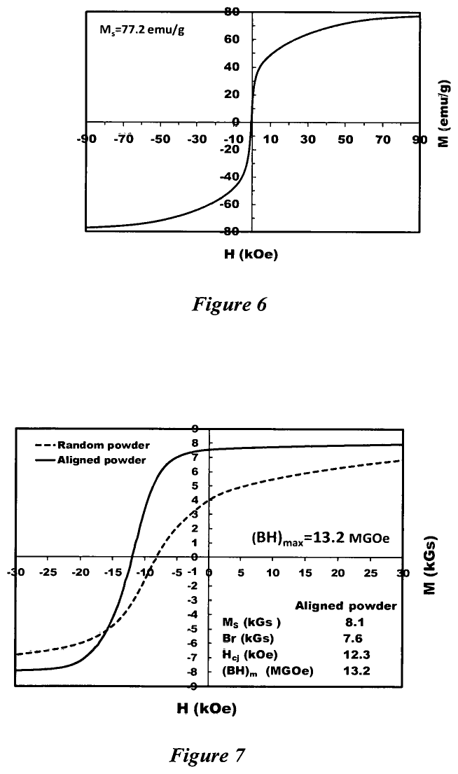

FIG. 6 illustrates magnetic properties of precursor ribbons annealed at 290° C. for 5 days. A Mₛ value of 77.2 emu/g is obtained, indicating that a purity more than 95% of LTP MnBi is achieved.

FIG. 7 shows magnetic properties of the feedstock powder produced as described above using the second approach of coating the particle exterior surfaces. An aligned powder sample exhibited a H_{cj} of 12.3 KOe, Mₛ of 8.1 kGs (or 72.5 emu/g at a field of 9 T), and a (BH)ₘₐₓ of 13.2 MGOe, respectively.

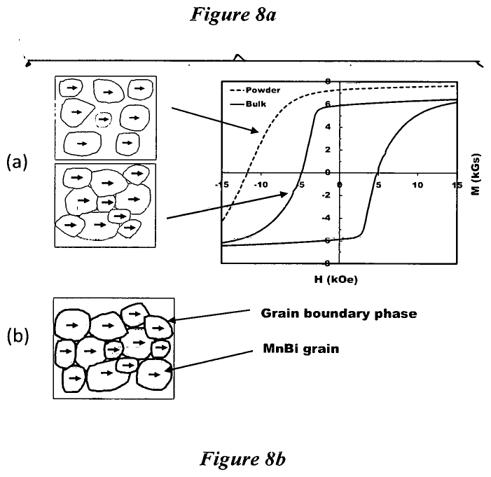

FIGS. 8a and 8b illustrate the effect of grain boundary phase on magnetic properties. A loose powder shows a H_{cj} of 11.5 due to no interaction between magnetic LTP MnBi particles. After being compacted, the LTP particles interact with each other, and H_{cj} is decreased to 4.8 kOe. Therefore, a beneficial microstructure should consist of LTP MnBi grains and non-magnetic grain boundary phase as shown in FIG. 8b.

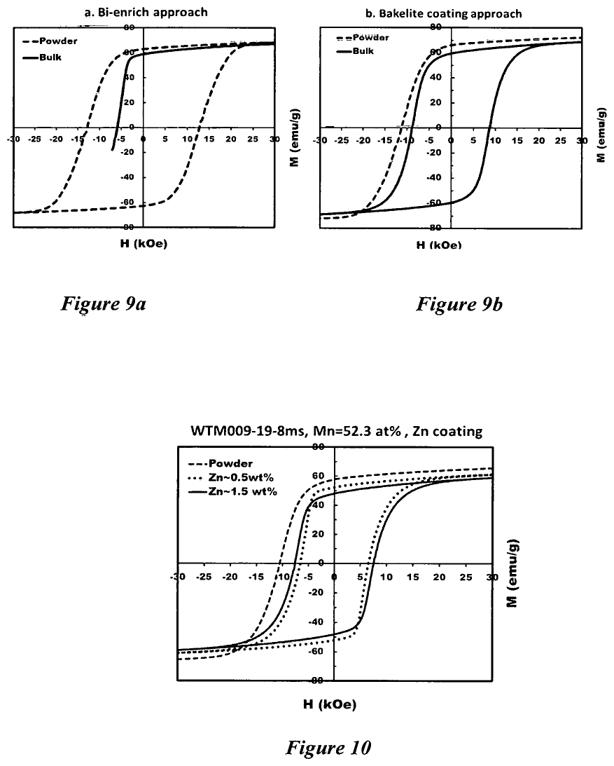

FIGS. 9a and 9b show the different interior grain and exterior grain methods to introduce a non-magnetic phase in and/or on the fine powder. Bulk permanent magnets fabricated by the two respective different approaches to obtain good magnetic properties are shown in FIG. 9a, 9b and Table 1. Relatively, the Bakelite coating is more effective to retain H_{cj} after the feedstock is consolidated.

TABLE 2
Magnetic properties of feedstock powder and bulk
magnet obtained by two different approaches

| | Mₛ | Mᵣ | H_{cj} | | (BH)ₘₐₓ |
|---|---|---|---|---|---|
| Sample | (emu/g) | (emu/g) | (kOe) | Mᵣ/M₉ | (MGOe) |
| Mn = 49.5 Powder | 68.2 | 62.8 | 12.8 | 0.92 | 11.5 |
| Mn = 50.8 Powder | 72.2 | 66.0 | 11.0 | 0.88 | 12.0 |
| Mn = 49.5 Bulk | 67.3 | 58.8 | 6.0 | 0.87 | 8.0 |
| Mn = 50.8 Bulk | 68.6 | 59.4 | 8.9 | 0.86 | 8.0 |

FIG. 10 shows another coating example using “Zn coating” on the deposited on the particles. Zn is coated onto the powder particles by using PVD (physical vapor deposition). With increasing coating amount of Zn, H_{cj} increases but Mₛ decreases.

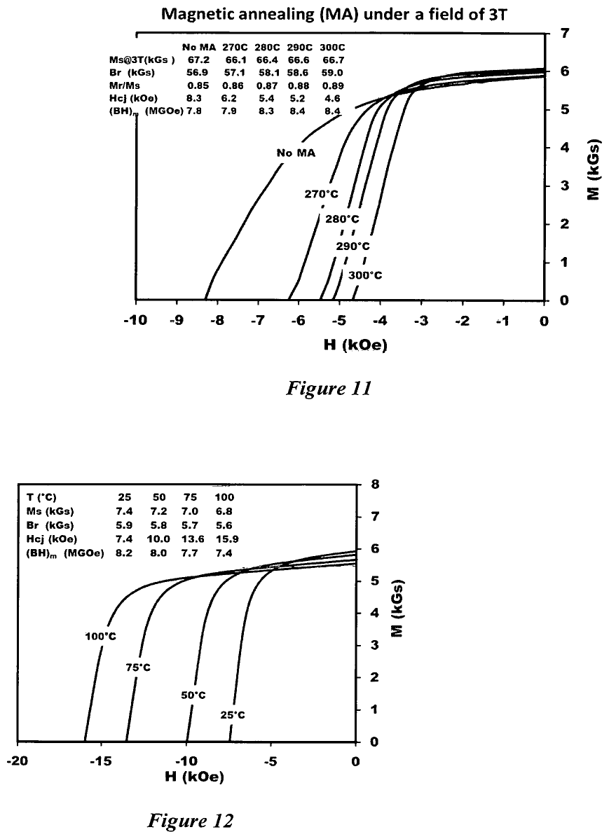

FIG. 11 shows the effect of magnetic annealing temperature on magnetic properties of bulk magnet. Magnetic annealing improves the squareness of demagnetization curves and thus increases (BH)ₘₐₓ of bulk magnet.

FIG. 12 shows magnetic properties of a typical bulk magnet processed through all disclosed process steps described above pursuant to an embodiment of the invention. The magnet exhibits very good magnetic properties at room and high temperatures.

The present invention produces mass quantities of high-purity α-MnBi feedstock powder and large scale bulk magnets are suitable for use in energy applications including, but not limited to, e.g., radiation shielding for nuclear energy due to Bi element with a high Z; electric generators; electric motors; electrical devices and high-temperature (>150° C.) applications. The present invention ensures that mass quantities (at kilogram scale) of powder or bulk magnets with high performance and different sizes are able to reproducible produce. The invented process is also easy to covert to industrial scale and produce high-purity α-MnBi feedstock powder and bulk magnets.

What is claimed is:

1. A process for fabricating a quantity of α-MnBi feedstock powder, comprising:
forming particles comprising Mn and Bi having at least about 90% by volume α-MnBi phase; comminuting the particles to a smaller size, and optionally annealing the comminuted particles at a temperature for a time to recover any decrease in a magnetic property resulting from comminution, wherein a further step is included among the steps recited above of providing at least one of (a) a non-magnetic material on surfaces of the particles by coating the particles with a non-magnetic material and (b) a non-magnetic material interiorly in the particles by forming a non-magnetic phase at grain boundaries of the particles.

2. A process for fabricating a quantity of a high-purity α-MnBi feedstock powder, comprising:
melting a selected ratio of manganese (Mn) metal and bismuth (Bi) metal with varied compositions (MnₓBi₁₀₀₋ₓ, x=48.5-53.5 at. %) to form an alloy and at least one of a) rapidly solidifying the melted alloy to form an ingot and b) melt-spinning the alloy at a wheel speed to form melt-spun ribbon flakes thereof;
annealing the ingot or melt-spun ribbon flakes to obtain MnBi precursor alloy to promote the formation of LTP MnBi phase (α-MnBi) in the precursor alloy therein to at least a purity of 90 volume %;
comminuting the ingot or the melt-spun ribbon to obtain fine powder with a particle size of 3 to 5 μm therein; and
providing a non-magnetic second phase in and/or on the fine powder by at least one of (a) forming a Bi-enriched phase interiorly of the particles at grain boundaries thereof and (b) coating a non-magnetic material on the surfaces of the particles.

3. The process of claim 2, wherein the molten alloy is rapidly solidified to form a composition-uniform ingot.

4. The process of claim 2, wherein the annealing temperature for the ingot or ribbon flakes is at about 270-350° C.

5. The process of claim 2, wherein the fine powder is ball or jet milled and annealed at 270-350° C. for 2-5 days.

6. The process of claim 2 wherein the non-magnetic material includes at least one of Zn, Bi, Sn, Sb, and Bakelite material.

7. The process of claim 6 wherein at least one of Zn and the non-magnetic Bakelite material is coated on exterior surfaces of fine powder to obtain the feedstock powder.

8. The process of claim 2, wherein the yield of the high-purity α-MnBi alloy product includes a mass of greater than or equal to about 100 grams in a single processing batch, or a mass greater than or equal to about 1 kilogram in a single processing batch.

9. The process of claim 2 that achieves the feedstock powder with a purity of α-MnBi higher than 90 volume %.

10. The process of claim 2, wherein the feedstock powder contains a high-purity α-MnBi phase and a non-magnetic second phase.

11. The process of claim 2, wherein the feedstock powder is incorporated as a component of a permanent magnet.

12. A process for preparing a large size of bulk magnet, comprising:
loading the feedstock powder of claim 1 into a non-magnetic die;
aligning the feedstock powder in the die in a magnetic field,
compacting the feedstock powder to obtain a densified green compact, and then magnetic annealing the green compact under a vacuum at 270-350° C. for a time under a magnetic field of 0.5 to 3 T.

13. The process of claim 12, wherein the size of the green compact is variable according to the different service applications.

14. The process of claim 12, wherein a cold isostatic pressing step of the green compact is conducted to increase the density thereof yet maintain magnetic alignment of the green compact.

15. The process of claim 12, wherein the magnetic annealing step of the bulk magnet further improves the grain alignment of magnet and enhance a magnetic property (BH)ₘₐₓ.

16. The process of claim 15, wherein the coercivity H_{cj} of bulk magnets is retained or only slightly reduced after the CIP step and magnetic annealing step.

17. The process of claim 2, including mixing the feedstock with a binder.

18. The process of claim 12, that produces a bulk magnet for incorporation as a component of an electric motor or electric generator.

19. A MnBi feedstock powder particles having at least one of (a) a non-magnetic coating on the powder particles and (b) a non-magnetic phase at grain boundaries of the powder particles.

20. A bulk magnet comprising consolidated feedstock powder of claim 19.
